(19) United States
(12) Patent Application Publication
(10) Pub. No.: US 2024/0062629 A1
(43) Pub. Date: Feb. 22, 2024

(54) COMPUTER IMPLEMENTED SYSTEM AND METHOD FOR PLACING WAGERS

(71) Applicant: Mark FITZSIMMONDS, South Morang, Victoria (AU)

(72) Inventor: Mark FITZSIMMONDS, South Morang, Victoria (AU)

(21) Appl. No.: 18/261,014

(22) PCT Filed: Jan. 7, 2022
(86) PCT No.: PCT/AU2022/050003

§ 371 Date: Jul. 11, 2023

(30) Foreign Application Priority Data
Jan. 11, 2021 (AU) 2021900041

(51) Int. Cl. G07F 17/32

(52) U.S. Cl. CPC G07F 17/3288; G07F 17/323

(57) ABSTRACT

A computer-implemented method enabling a gambler to place a wager in respect of a selection of one or more race animals by an expert, the method including, receiving, by one or more processors, data relating to a plurality of uniquely identified race animals, the data including, a video stream of images of the race animals prior to a race event in respect of which the race animals are scheduled to participate, and information provided by one or more experts assessing the race fitness of the animals during viewing of the video stream, causing, by the one or more processors, the data to be transmitted and displayed upon a graphical user interface associated with a data communications device associated with the gambler such that the video stream and the information provided by the one or more experts is available to the gambler in substantially real-time, causing, by the one or more processors, odds associated with wagering upon different possible selections by the one or more experts to be transmitted and displayed upon the graphical user interface associated with the data communications device, receiving, by the one or more processors, from the data communications device, a wager in respect of a selection of one or more race animals by the one or more experts, based upon detecting that the one or more experts has made a selection of one or more race animals, determining, by the one or more processors, an outcome of the wager, and causing, by the one or more processors, an outcome of the wager to be transmitted and displayed upon the graphical user interface associated with the data communications device.

### FIELD OF THE INVENTION

The present invention relates to a computer implemented system and method of wagering that co-ordinates and schedules video streaming of relevant images and the placement of wagers enabling gamblers to remotely place wagers in respect of a selection by an expert regarding race animals (e.g., horses, dogs, etc.) that are available for viewing in real-time shortly before a race that, in the expert's view, represent the best prospects of winning, or securing a place, in the event. The invention is well suited to subsequently following the animals in the race and enabling gamblers to place further wagers regarding the race.

### BACKGROUND OF THE INVENTION

Contests in horse racing, dog racing and various other contests between animals have been conducted throughout history and such contests are attractive to the general public as a form of entertainment. Over time, the entertainment value of contests between animals has increased significantly.

Simultaneously, the general public have throughout history sought to gamble upon the outcome of a contest between animals. As the business value of the entertainment aspect of contests has increased, the business value of gambling upon the outcome of such events has also increased and presently represents a substantial industry.

Placing wagers on the outcome of a race by individuals selecting one or more animals that are predicted to win is a common form of wagering. As part of this process, individual gamblers tend to follow the performance of one or more animals across a number of racing events which are published in a “form guide” (i.e., an online or printed publication containing statistics and other information regarding the racing performance of each of the animals).

Although information available in “form guides” representing past race-performances of an animal greatly assists gamblers when placing a wager on one or more preferred animals for an event, such information does not take into account race day conditions, or the up to date condition of the animal on the day of the race.

Since the race day conditions and the condition of the animal on the day of the race will significantly impact the outcome of a race, many individuals wait until the actual day of the race to place a wager and in some instances, individual gamblers will wait until minutes before the race to place a wager at which time the latest information regarding the race animal is usually made available to the wagering public. Some gamblers attend the race track on the day of the race to observe the condition of the participating animals. However, this is inconvenient, or sometimes not possible, for many gamblers, and accordingly, many individuals can lose interest in placing a wager, or experience a significant disadvantage, as compared with those who attend the event.

To address this concern for remotely located gamblers, the presentation of race animals just before a race is televised so that gamblers may view the race animals substantially simultaneously with those gamblers who are physically present at the tracks. The broadcast is also generally accompanied by commentary from an expert who provides their views regarding the animals who are in the best race condition.

The provision of an expert's opinion regarding the animals considered to comprise those who are the best “race fit” on the day is of interest to gamblers who seek to predict the expert's opinion. Further, following the selection of the best “race fit” animals prior to the race, gamblers are also interested in following those animals during the race.

With currently available systems, it is not possible to observe, in real-time, animals on parade before a race and subsequently follow the animals during the race from the same platform, or at least, with the parade “linked” to the subsequent race such that gamblers who partake in viewing and/or placing a wager in respect of the parade and expert's opinion, may also easily follow the race event and view and/or place wagers in respect of same. Available computer implemented systems do not integrate data from the range of sources necessary to enable the efficient viewing of real-time video whilst simultaneously monitoring the recordal of one or more expert opinions regarding the race animals displayed in the video and further, enable gamblers to place a wager regarding an expert's opinion with knowledge regarding the available time in which to place a wager.

Existing systems require a gambler to conduct searching to locate a particular “viewing” of race animals and subsequently locate the actual race event in which those viewed race animals subsequently participate. The computer-implemented system and method of present invention seeks to address the above identified problems or at least provide an alternative solution to same.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented method enabling a gambler to place a wager in respect of a selection of one or more race animals by an expert, the method including receiving, by one or more processors, data relating to a plurality of uniquely identified race animals, the data including a video stream of images of the race animals prior to a race event in respect of which the race animals are scheduled to participate, and information provided by one or more experts assessing the race fitness of the animals during viewing of the video stream, causing, by the one or more processors, the data to be transmitted and displayed upon a graphical user interface associated with a data communications device associated with the gambler such that the video stream and the information provided by the one or more experts is available to the gambler in substantially real-time, causing, by the one or more processors, odds associated with wagering upon different possible selections by the one or more experts to be transmitted and displayed upon the graphical user interface associated with the data communications device, receiving, by the one or more processors, from the data communications device, a wager in respect of a selection of one or more race animals by the one or more experts, based upon detecting that the one or more experts has made a selection of one or more race animals, determining, by the one or more processors, an outcome of the wager, and causing, by the one or more processors, an outcome of the wager to be transmitted and displayed upon the graphical user interface associated with the data communications device.

In an embodiment, the race animals are horses and the video stream shows the horses parading around a yard prior to entry to a race track.

In an embodiment, the selection made by the one or more experts relates to which race animal is most race fit and/or most likely to win the race event and/or most likely to be placed, and the outcome of the wager is determined based upon an extent to which a selection made by the gambler matches the selection made by the one or more experts.

In an embodiment, the selection made by the one or more experts is detected by identifying when the one or more experts has made an announcement regarding their opinion with respect to which of the race animals is/are most race fit and most likely to win the race event. In an alternate embodiment, the announcement is made at a predetermined time prior to the race event. In this embodiment, the data communications device may be caused to display a timer that counts down to the predetermined announcement time.

In an embodiment, the gambler receives the selection by the expert in audible form during viewing of the video stream. In an embodiment, the data communications device is also caused to display the selection by the expert in textual form.

In an embodiment, the wager is in the form of a single bet relating solely to the selection by the one or more experts according to the assessment of the race fitness of the animals by the one or more experts. Following determination of the outcome of the wager, the gambler may be prompted to place a second wager in relation to another aspect of the race event. In this regard, the gambler may be prompted to place a further wager in relation to an outcome of the race event. For example, the further wager may relate to selection of a race animal that will win the race event, or selection of race animals that will receive a place (e.g. first, second and/or third).

In another embodiment, the wager is in the form of a multi-leg bet in which a first leg relates to the selection by the one or more experts of the race fitness of the animals, and a second leg relates to another aspect of the race event.

In an embodiment, the aspect of the race event that is the subject of a second leg of the multi-leg bet relates to an outcome of the race event. For example, the second leg of the multi-leg bet relates to selection of a race animal that will win the race event, or selection of race animals that will receive a place (e.g. first, second and/or third).

In an embodiment, the second leg bet relates to race animal(s) that are the same as the race animal(s) selected in respect of the first leg bet. In another embodiment, the second leg bet relates to race animal(s) that are different to the race animal(s) selected in respect of the first bet. In yet another embodiment, the second leg bet relates to a combination of race animal(s) that are the same as those selected in respect of the first leg bet and race animal(s) that are different to those selected in respect of the first leg bet.

In an embodiment, the second leg of the multi-leg bet is placed automatically based upon the gambler's selection in the first leg of the multi-leg bet. For example, if the first leg of the multi-leg bet involves selection by the gambler of a particular race animal, the particular race animal is automatically selected as a race winner or as an animal that will achieve a placing in the second leg of the multi-leg bet. In this regard, the wager placed by the gambler, including any automatic selections and monetary amounts to be bet, may be based upon pre-defined preferences of the gambler.

In another aspect, the present invention provides a system for a gambler to place a wager in respect of a selection of one or more race animals by one or more experts, the system including, one or more memories, and one or more processors operable to, receive data relating to a plurality of uniquely identified race animals, the data including, a video stream of images of the race animals prior to a race event in respect of which the race animals are scheduled to participate, and information provided by one or more experts assessing the race fitness of the animals during viewing of the video stream, cause the data to be transmitted and displayed upon a graphical user interface associated with a data communications device associated with the gambler such that the video stream and the information provided by the one or more experts is available to the gambler in substantially real-time, cause odds associated with wagering upon different possible selections by the one or more experts to be transmitted and displayed upon the graphical user interface associated with the data communications device, receive, from the data communications device, a wager in respect of a selection of one or more race animals by the one or more experts, based upon detecting that the one or more experts has made a selection of one or more race animals, determine an outcome of the wager, and cause an outcome of the wager to be transmitted and displayed upon the graphical user interface associated with the data communications device.

In another aspect, the present invention provides a computer-readable medium having a plurality of instructions that enable a gambler to place a wager in respect of a selection of one or more race animals by one or more experts, the instructions executable by one or more processors to, receive data relating to a plurality of uniquely identified race animals, the data including, a video stream of images of the race animals prior to a race event in respect of which the race animals are scheduled to participate, and information provided by one or more experts assessing the race fitness of the animals during viewing of the video stream, cause the data to be transmitted and displayed upon a graphical user interface associated with a data communications device associated with the gambler such that the video stream and the information provided by the one or more experts is available to the gambler in substantially real-time, cause odds associated with wagering upon different possible selections by the one or more experts to be transmitted and displayed upon the graphical user interface associated with the data communications device, receive, from the data communications device, a wager in respect of a selection of one or more race animals by the one or more experts, based upon detecting that the one or more experts has made a selection of one or more race animals, determine an outcome of the wager, and cause an outcome of the wager to be transmitted and displayed upon the graphical user interface associated with the data communications device.

### BRIEF DESCRIPTION OF THE DRAWINGS

Embodiments of the invention will now be described in further detail with reference to the accompanying Figures in which:

FIG. 1 illustrates an exemplary computer-implemented system for placing wagers in accordance with the present invention;

FIG. 2 illustrates an exemplary flow diagram associated with the server component of the system illustrated in FIG. 1;

FIG. 3 illustrates an exemplary flow diagram of a process that enables a video stream of images of race animals prior to a race event to be captured along with information informed by one or more experts during viewing of the video stream;

FIG. 4 illustrates an exemplary flow diagram of a process that enables a user to download and install a software application and subsequently log in, or register, to use the software application for interacting with the system illustrated in FIG. 1, including establishing a wagering account;

FIG. 5 illustrates an exemplary flow diagram of a process that enables the user to view the data captured during the process shown in FIG. 3 and place a wager in respect of a selection of one or more race animals by the experts; and

FIG. 6 illustrates an exemplary flow diagram of a process that enables the user to view an outcome of their wager.

### DETAILED DESCRIPTION OF EMBODIMENT(S) OF THE INVENTION

For simplicity and illustrative purposes, the present disclosure is described by referring to one or more embodiments thereof. In the following description, numerous specific details are set forth in order to provide a thorough understanding of the present disclosure. However, it will be readily apparent, that the present disclosure may be practiced without limitation to these specific details. In other instances, some methods and structures have not been described in detail to avoid obscuring the present disclosure.

As used herein, the terms “a” and “an” are intended to denote at least one of a particular element, the term “includes” means includes but not limited to, the term “including” means including but not limited to, and the term “based on” means based at least in part on.

The present invention relates to at least a computer-implemented system and method for enabling a gambler (180) to place a wager in respect of a selection of one or more race animals (130A, 130B, 130C) by an expert (160A, 160B). In the example described, there is a selection of a particular race horse by one or more experts viewing a pre-race parade of all participating race horses. The system and method utilize a central server (20) in communication with data communications devices (190) associated with one or more gamblers, as well as any additional devices that may be required to capture data (100) relating to the race animals (130A, 130B, 130C).

The central server (20) maintains one or more processors and/or databases for performing functions including receiving the data (100) relating to a plurality of uniquely identified race animals (130A, 130B, 130C), wherein the data (100) includes a video stream of images of the race animals prior to a race event (350) in respect of which the race animals are scheduled to participate, and information provided by one or more experts (160A, 160B) assessing the race fitness of the animals during viewing of the video stream. In other words, the data (100) that is received includes a video stream of race animals (e.g. race horses just prior to the commencement of the race where the animals are paraded in a mounting yard (120)), as well as information (e.g. audible commentary) provided by experts who assess the race fitness of the animals and also provide an opinion with respect to the race fitness and/or likely winner of the race event (350), wherein the experts provide information based upon their own viewing of the video stream of images.

When the data (100) relating to the plurality of uniquely identified race animals (130A, 130B, 130C) is captured and presented to a gambler (180), i.e. by displaying same upon a graphical user interface associated with a data communications device (190) associated with the gambler (180), the gambler (180) is provided with the same video stream as presented to the one or more experts (160A, 160B). In this way, the video stream and additional information such as commentary by the one or more experts is available to the gambler (180) in substantially real-time. Additional information that is presented is to the gambler (180) includes odds associated with different wagering options, e.g. associated with different possible selections by the one or more experts (160A, 160B).

Leading up to the commencement of the race event (350), the gambler (180) is invited to place a wager in respect of a selection of one or more race animals (130A, 130B, 130C) by the one or more experts (160A, 160B), e.g. a selection of one or more race animals which the experts consider are the most “race fit” and thereby the most likely to win the race event (350).

Based upon detecting that the one or more experts (160A, 160B) has made a selection, an outcome of the wager may be determined and subsequently presented to the gambler (180) through the same graphical user interface associated with data communications device (190), which may be the gambler's mobile phone for example.

The skilled reader will appreciate that the above described system and method, when applied to a horse race allows gamblers (also known as “punters”) to place a wager upon a prediction regarding the most likely horse or horses that will be selected by one or more experts, e.g. as being the most “race fit” and/or the most likely to win the race. Accordingly, the outcome of the wager will be dependent upon the selection that is ultimately made by the one or more experts. Whilst gamblers can be guided by commentary of the experts, they need not be influenced by the expert's commentary and make a selection based upon their own viewing of the race animals and their own opinions. In this way, gamblers can test their opinions against experts who are viewing identical mounting yard vision.

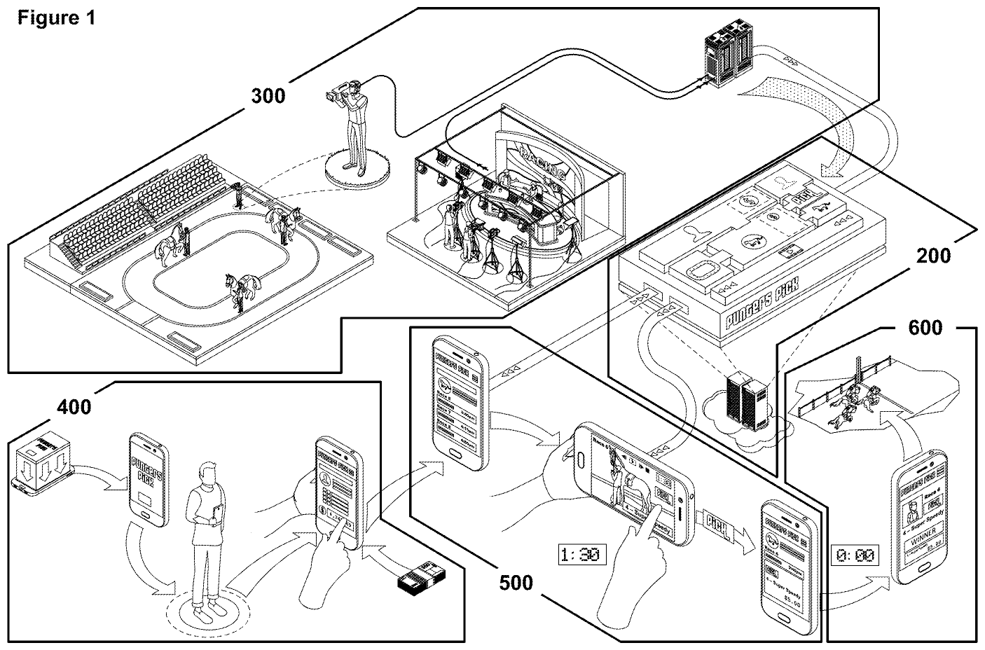

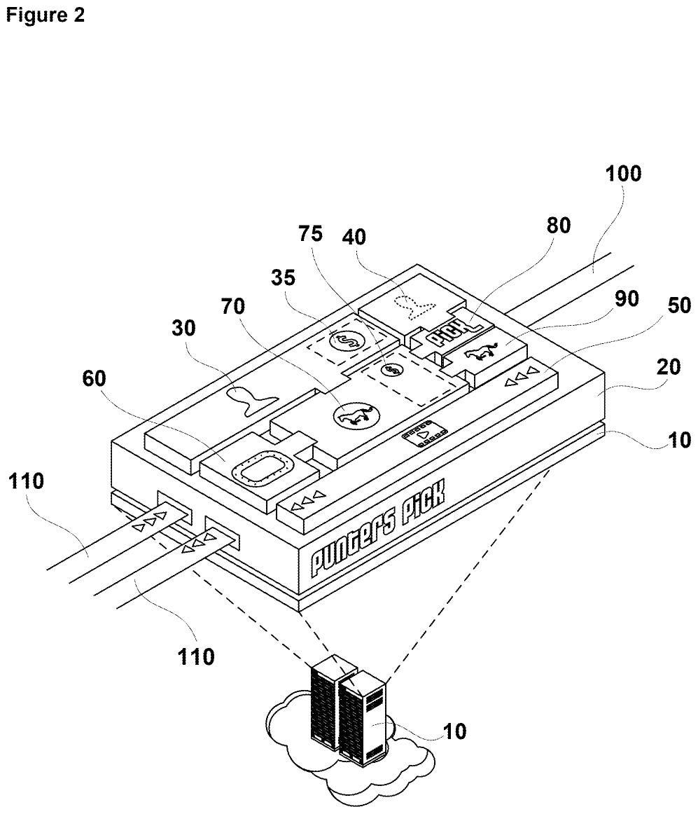

FIG. 1 is divided into segments which are further expanded in the subsequent FIGS. 2 to 6. In particular, segment 200 of FIG. 1 shows the server component (20) in respect of which a software application (210) operating on the gambler device (190) is configured to communicate. This is expanded in FIG. 2, and the skilled reader will appreciate that the steps described herein as performed by the device (190) may be facilitated by the software application (210) that operates on the device. The software application (210) could also operate on a computer such as a desktop computer or laptop.

As an alternative, or in addition to the steps performed by the server (20), steps described herein could also be performed by one or more processors associated with the user device (190). Different arrangements are possible in this regard, but according to a particular implementation, the server (20) is programmed to provide all of the functions described herein that cannot be provided locally on the device (190).

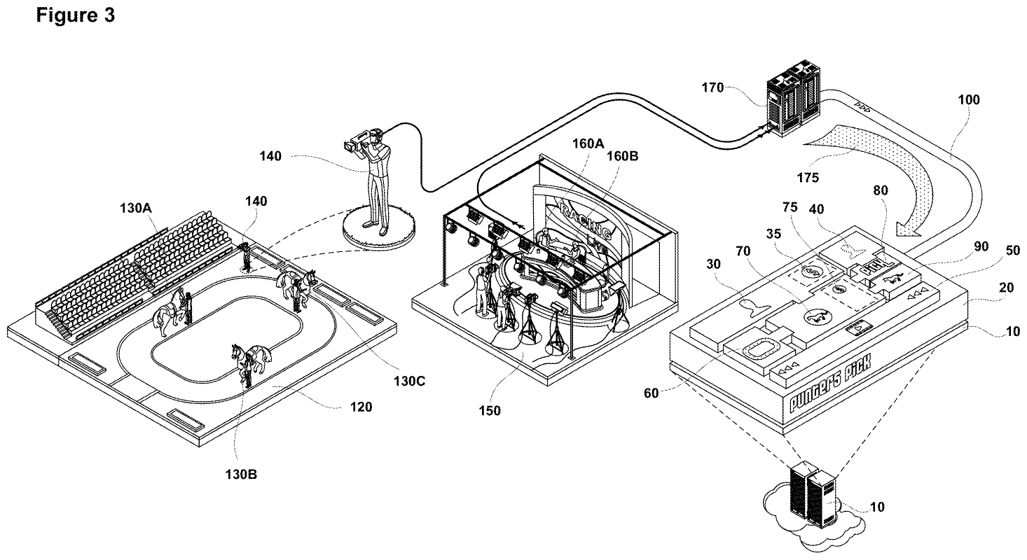

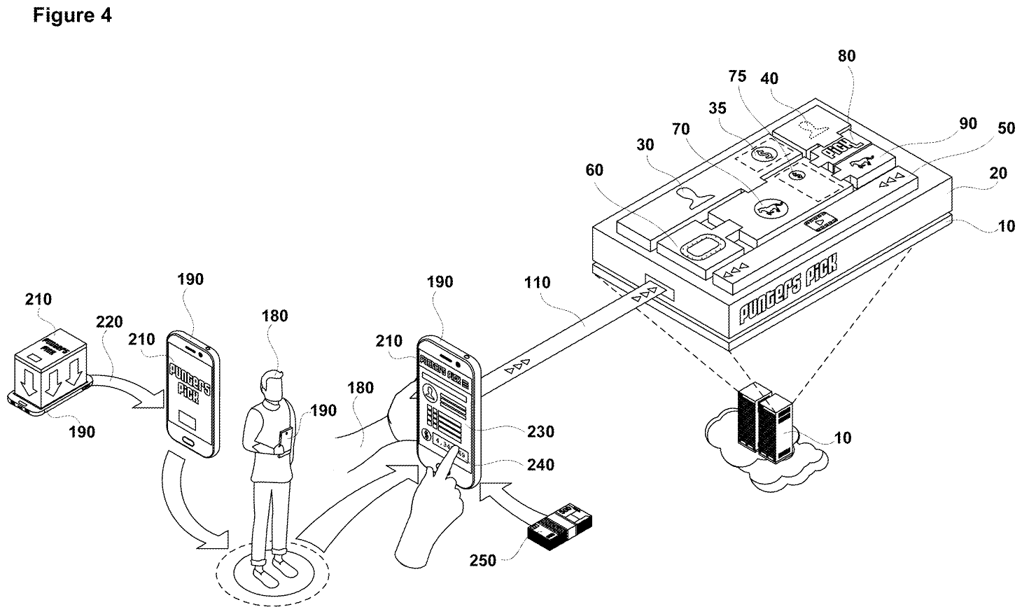

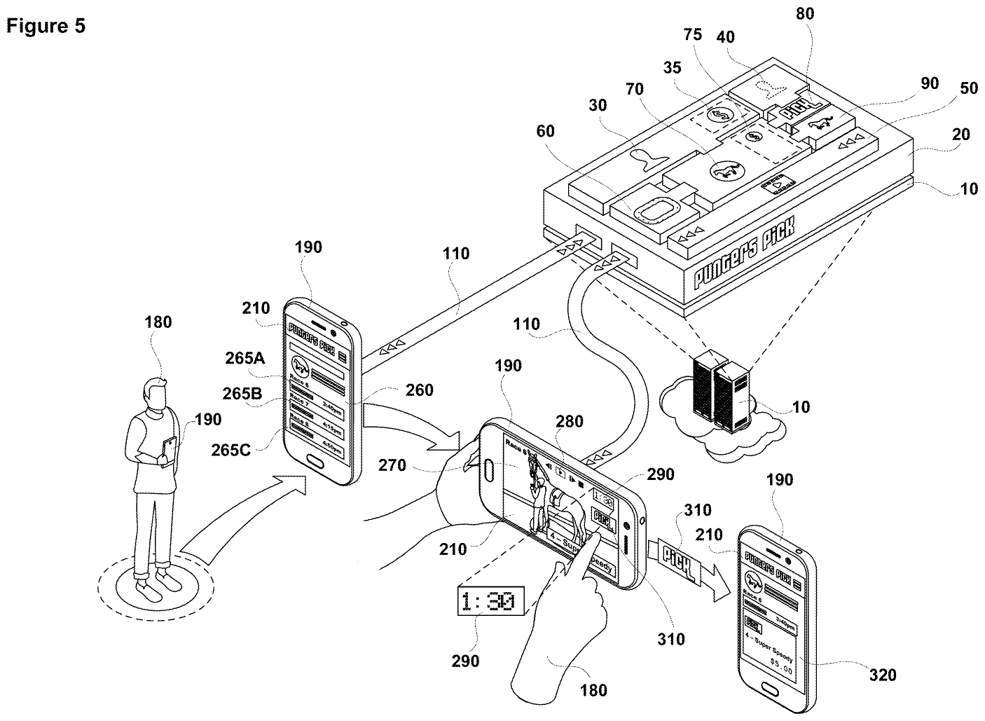

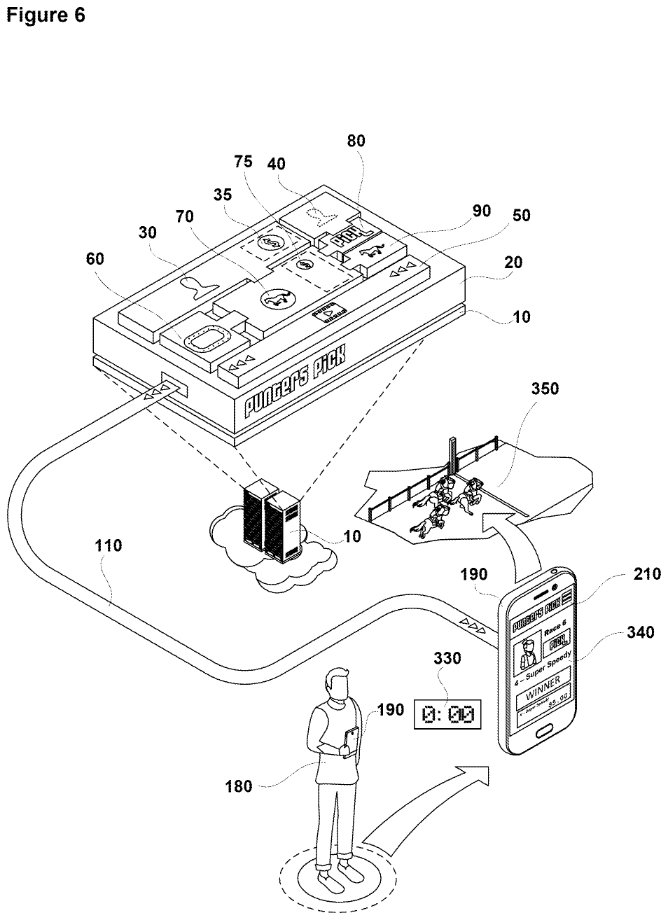

Segment 300 of FIG. 1 shows an example of how data (100) relating to the video stream and information provided by the one or more experts (160A, 160B) may be collected, which is expanded in FIG. 3. Segment 400 of FIG. 1 shows a gambler (180) downloading and installing the application (210) and subsequently logging into the application (210) to establish a wagering account, which is expanded in FIG. 4. Segment 500 of FIG. 1 illustrates the above described process of the gambler (180) placing a wager in respect of a selection of one or more of the racing animals (130A, 130B, 130C) by one or more of the experts (160A, 160B), which is expanded in FIG. 5. Finally, segment 600 of FIG. 1 illustrates how an outcome of a wager may be displayed to the gambler (180), as expanded in FIG. 6.

As mentioned above, FIG. 2 shows in greater detail segment 200 of FIG. 1. In particular, FIG. 2 shows the server component (20) which includes infrastructure (10) upon which the platform of the present invention operates. The infrastructure (10) may be local or cloud-based. The central server (20) may operate one or more computer processors and maintain one or more databases that enable the following functionality and/or storage:
User account register (30) which stores profiles of gamblers (180) who have registered to use the application (210), including key information about each gambler such as name, age, address, contact details, and any additional details that may be required to satisfy identity requirements for gambling in a particular jurisdiction;
Wagering account (35) which acts as a virtual bank account for each gambler (180), the account containing funds (or virtual funds) belonging to each gambler that may be used to place wagers with a gambling service provider in respect of the selection of a race animal by one or more experts as described herein;
Expert register (40) which stores profiles of experts such as experts (160A, 160B) whose responsibility is to provide an independent analysis of the race animals as they parade around the mounting yard (120) prior to the race event (350) and an opinion regarding the animal or animals they consider to be the most race fit and hence most likely to win. The register (40) stores similar details as register (30), including for example, the name, age, address, and contact details of each expert;
Functionality (50) for receiving and processing a live video stream of the race animals prior to the event. This stream of data may include a video stream of images of the race animals, as well as audio representing information informed by the experts during viewing of the video stream;
Repository (60) for storing a schedule of race events available for selection by gamblers (180) at any one time;
Functionality (70) for receiving and processing wager information placed by the gamblers in user account (30), which as described in greater detail below, may include multiple legs (e.g. a multi-leg bet);
Repository (75) for storing the result of each wager including details regarding funds transferred to and from the gambler (180) which will be dependent upon the success, or otherwise, of their wagers;
Repository (80) for storing the results of selections by the one or more experts (160A, 160B) in relation to a race animal. It is information from this repository that is revealed to gamblers after a selection of one or more race animals by the experts has been detected;
Race outcome repository (90) which stores details regarding the horse racing event (350), including placements and other information that may be stored for future reference, and which may also become useful in circumstances where the gambler (180) places a multi-leg bet in which a further wager is placed based upon the race outcome.

FIG. 2 also shows that the server (20) is configured to enable communication (110) with the gambler device (190) and in particular the software application (210) operating on the gambler device (190).

FIG. 3 shows in greater detail segment 300 of FIG. 1 and, in particular, how a camera operator (140) located at the race event (350) and in particular the mounting yard (120), i.e. the trackside location where horses (130A, 130B, 130C) are paraded prior to the racing event (350), captures a video stream. As the video stream is captured by the camera operator (140), it may be received by infrastructure (170) which processes the video stream together with data received from a broadcast studio (150) at which the experts (160A, 160B) are located. For example, the data from broadcast studio (150) may be in the form of an audio stream representing commentary by the experts (160A, 160B). Such a data file will complement the video stream received from the camera operator (140) since the commentary by the experts is in relation to their viewing of the video stream captured by the camera operator (140). The infrastructure (170) may then process the video stream and information informed by the experts (160A, 160B) and transform same into the data stream (100) which is subsequently displayed to the gambler (180), as previously described.

The video stream is typically sufficient to clearly show video images of each race animal competing in the event (350). Since the same video stream is shown to each of the experts (160A, 160B), there can be no suggestion that the gamblers are disadvantaged with respect to making a race animal selection. Indeed, the gamblers (180) may also receive additional information in the form of commentary from the experts. However, it will be appreciated that the commentary of the experts may be varied and not necessarily indicative of a final selection that will be made by an expert.

FIG. 4 shows in greater detail segment 400 of FIG. 1 and, in particular, the steps of a gambler (180) installing the application (210), which may be achieved by downloading the application (210) from an Application store. The gambler (180) may create an account (240) using the application (210) and the account information may be stored in the user account register (30). The user account register (30) may capture information sufficient to enable the gambler (180) to be correctly identified. The process of installing the application (210) is indicated by arrow (220), and an interface (230) is also shown which allows the gambler (180) to download and install the application (210) in order to access the functionality thereof including to view the balance of funds in a wagering account (35) associated with the gambler (180), as shown in interface (240), and to manage the funds (250). In particular, the gambler (180) may deposit funds (250) into and withdraw funds (250) from the virtual wagering account (35).

Whilst not shown, each expert (160A), (160B) may be required to undertake a similar registration process in order to register their details for subsequent storage in register (40).

The virtual wagering account (35) may be linked to an actual bank account associated with a financial institution of the gambler (180) such that funds are transferable between the bank account and the virtual wagering account (35). The virtual wagering account (35) is then available for the purpose of placing wagers and collecting winnings using application (210) operating on the gambler's device (180).

As shown in FIG. 5, a gambler (180) may also utilize software application (210) to view information relating to upcoming horse racing events (265A, 265B, 265C). In respect of an event for which racing animals have already commenced a public parade, the application (210) may also enable the gambler to switch over to the live stream of the parade. In this regard, the interface (260) shown in FIG. 5 may be used by the gambler (180) to view and be alerted regarding when horses for upcoming races enter a mounting yard (120). Based upon selection of a particular event by the gambler (180), the application (210) may generate a further interface (270) in which the live video feed captured by camera operator (140) is displayed, i.e. alive video feed of the mounting yard vision. The interface (270) may also display odds associated with different race animals and such odds may fluctuate as the race event approaches.

Interface (260) may further include vision controls (280) which enable a user to pause, rewind, zoom or otherwise control the vision on their device (190), as well as a countdown timer (290) indicating the time remaining within which the gambler may select and place a wager in respect of a race animal, or animals, most likely to be selected by the one or more race experts (e.g. a race animal considered to be the most race fit, and/or most likely to win the particular race event). The countdown timer (290) may also provide visual alerts such as changing colour and/or flashing to warn the gambler as the deadline for placing a wager approaches.

When the gambler (180) is ready to place a wager, they may select a prompt (310), viewable in interface (260), which generates a further interface (320) that enables the gambler to enter details regarding a wager. In particular, the gambler (180) may be prompted with respect to the monetary amount to be included in the wager, and the type of wager (e.g. single-leg bet or multi-leg bet). Ultimately, the gambler (180) will be requested to confirm their wager based upon all entered information.

As mentioned above, the wager may be in the form of a single bet relating solely to a selection of a race animal, by the one or more experts (160A, 160B), based upon their assessment of the race fitness of the animals (130A, 130B, 130B). However, the gambler (180) may be prompted to place a second wager in relation to a further aspect of the race event (350). In this regard, the gambler (180) may be prompted to place a second single-leg wager in relation to an outcome of the actual race event (350). For example, the further wager may relate to selection of a race animal that will win or achieve a placing in the forthcoming race event (350).

In an alternative embodiment, the initial wager placed is in the form of a multi-leg bet in which a first leg relates to the selection by the one or more experts (160A, 160B), and a second leg relates to the further aspect of the race event such as the outcome of the race event (350). For example, the second leg of the multi-leg bet may relate to selection of a race animal that will win the race or receive a place in respect of the race (e.g. first, second and/or third place). It is to be understood that if a gambler (180) selects a particular race animal in the first leg, there is no obligation upon the gambler (180) to select the same animal in respect of the second leg. Indeed, different animals may be selected across the first and second legs.

In a further embodiment, the second leg of the multi-leg bet may be placed automatically according to the gambler's selection in the first leg of the multi-leg bet. For example, if the first leg of the multi-leg bet involves selection by the gambler (180) of a particular race animal (130A, 130B, 130B), the particular race animal may be automatically selected as a race winner or as an animal that will receive a place in the event in the second leg of the multi-leg bet. In this regard, each gambler (180) may provide pre-defined preferences which define automatic selections and/or the automatic application of monetary amounts to particular bets in advance. As will be appreciated by a skilled reader, the provision of pre-defined preferences substantially reduces the complexity associated with the user selecting individual options which improves the user experience whilst also reducing the data transfer to/from the gambler's (180) device thereby avoiding the use of computing resources that would otherwise be required associated with monitoring a potentially complex set of options selected by a gambler (180).

FIG. 6 shows in greater detail segment 600 of FIG. 1 and demonstrates an example regarding how a selection made by the one or more experts (160A, 160B) may be revealed to the gambler (180). In the embodiment shown, there is a countdown timer (330) wherein, at a predetermined time prior to the race event (350), the timer will reach zero and the experts (160A, 160B) will reveal their selection(s).

In an embodiment where there is no predetermined time scheduled for such an announcement, for example where the experts provide an opinion at the end of such commentary (a short period of time prior to the race event) announcing their selections, the selection may be detected by identifying that the one or more experts has made an announcement regarding their opinion. In this regard, the server (20) may include functionality that receives and processes audio signals such that an opinion of an expert may be automatically detected based upon processing the audio of the expert commentary.

Irrespective of how the selection made by the one or more experts is detected, the selection is subsequently displayed to the gambler (180). In the embodiment shown, this information is displayed in user interface (340) which allows the gambler (180) to view the expert selection and also the result of their wager in respect of same. FIG. 6 also shows the actual race event (350) which will follow the selection made by the experts, and as mentioned previously, wagers may also be placed upon the outcome of the actual race event (350) either individually or as part of a multi-leg bet.

In circumstances where there is more than one expert such as in the embodiment of FIG. 3 which illustrates two experts (160A and 160B), it will be understood that the wager placed by a gambler (180) may relate to the selection by one or both of the experts, i.e. the gambler (180) may be prompted to select the opinion of a particular expert or a group of experts upon which the success or otherwise of their wager is dependent. Similarly, the wager placed by the gambler (180) need not necessarily be limited to a single race animal but may relate to, for example, selection of multiple race animals made by more than one expert.

It will also be understood that whilst the present description and the accompanying Figures relate specifically to horse racing, whereby the race animals are race horses and the experts (160A, 160B) provide commentary in relation to the condition, fitness, behavior and preparation of each race horse prior to a horse racing event, the present invention is equally applicable to other race events.

It is to be understood that the user device (180) could be a tablet computer, a smartphone, a laptop computer, a desktop computer, or another type of computing device. The user device (180) may include a display that provides an interface for the user to input and/or view information. For example, a user could interact with the device using a program executed on a laptop computer, such as a text-based chat program, a voice-based communication program, and/or a video-based communication program. Alternatively, in some cases, the user device (180) could be a telephone (e.g., a landline, cell phone, etc.).

The central server (20) may be a single computer, the partial computing resources of a single computer, a plurality of computers communicating with one another, or a network of remote servers (e.g., cloud). The one or more servers (20) can house local databases and/or communicate with one or more external databases.

The user device (180) may communicate with the server (20) over a network. In some embodiments, the network may be a wide area network (“WAN”), e.g., the Internet. In other embodiments, the network may be a local area network (“LAN”). For example, in a more remote location far from a metropolitan area, the Internet may not be available. In yet other embodiments, the network may be a combination of a WAN and a LAN. In embodiments where the user device (180) is a phone (e.g., a landline or a cell phone), the communication may pass through a telecommunications network and/or a wide area network.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A computer-implemented method enabling a gambler to place a wager in respect of a selection of one or more race animals by an expert, the method including:
receiving, by one or more processors, data relating to a plurality of uniquely identified race animals, the data including:
a video stream of images of the race animals prior to a race event in respect of which the race animals are scheduled to participate, and
information provided by one or more experts assessing the race fitness of the animals during viewing of the video stream;
causing, by the one or more processors, the data to be transmitted and displayed upon a graphical user interface associated with a data communications device associated with the gambler such that the video stream and the information provided by the one or more experts is available to the gambler in substantially real-time;
causing, by the one or more processors, odds associated with wagering upon different possible selections by the one or more experts to be transmitted and displayed upon the graphical user interface associated with the data communications device;
receiving, by the one or more processors, from the data communications device, a wager from the gambler in respect of a selection by the gambler of one or more race animals that the gambler predicts will be selected by the one or more experts;
detecting, by the one or more processors, prior to the race event, that a selection had been made by the one or more experts by identifying that the one or more experts has confirmed their opinion with respect to which of the race animals are most race fit and/or most likely to win or be placed at the race event;
based upon detecting that the one or more experts has made a selection of one or more race animals, determining, by the one or more processors, an outcome of the Rambler's wager; and
causing, by the one or more processors, an outcome of the wager to be transmitted and displayed upon the graphical user interface associated with the data communications device.

2. A method according to claim 1, wherein the data communications device also receives an activatable link enabling the gambler to pre-request live streaming of the race event in which the one or more race animals participate.

3. A method according to claim 1, wherein the outcome of the wager is determined based upon an extent to which the selection made by the gambler matches the selection made by the one or more experts.

4. (canceled)

5. A method according to claim 1, wherein the confirmation of the opinion of the ne or more exerts is by way of an announcement by the one or more experts which is required to be made by a predetermined time prior to the race event.

6. A method according to claim 5, wherein the data communications device is caused to display an indication confirming the availability to submit a wager and an expected time remaining until the announcement.

7. A method according to claim 1, wherein the gambler receives the selection by the one or more experts in audible form during viewing of the video stream.

8. A method according to claim 1, wherein the data communications device is caused to display the selection by the one or more experts in textual form.

9. A method according to claim 1, wherein the wager is in the form of a single bet relating solely to the selection by the one or more experts according to the assessment of the race fitness of the animals by the one or more experts.

10. A method according to claim 1, wherein following a determination of the outcome of the wager regarding race fitness of animals, the gambler is prompted to place a second wager in relation to another aspect of the race event.

11. A method according to claim 10, wherein the second wager is in relation to an outcome of the race event.

12. A method according to claim 1, wherein the wager is in the form of a multi-leg bet in which a first leg relates to the selection by the one or more experts of the race fitness of the animals, and a second leg relates to another aspect of the race event.

13. A method according to claim 12, wherein the other aspect of the race event that is the subject of a second leg of the multi-leg bet relates to an outcome of the race event.

14. A method according to claim 12, wherein the second leg bet relates to race animal(s) that are the same as the race animal(s) selected in respect of the first leg bet.

15. A method according to claim 12, wherein the second leg bet relates to race animal(s) that are different to the race animal(s) selected in respect of the first bet.

16. A method according to claim 12, wherein the second leg bet relates to a combination of race animal(s) that are the same as those selected in respect of the first leg bet and race animal(s) that are different to those selected in respect of the first leg bet.

17. A method according to claim 12, wherein the second leg of the multi-leg bet is placed automatically according to the gambler's selection in the first leg of the multi-leg bet.

18. A computer-implemented system for a gambler to place a wager in respect of a selection of one or more race animals by one or more experts, the system including:
one or more memories, and
one or more processors operable to:
receive data relating to a plurality of uniquely identified race animals, the data including:
a video stream of images of the race animals prior to a race event in respect of which the race animals are scheduled to participate, and
information provided by one or more experts assessing the race fitness of the animals during viewing of the video stream;
cause the data to be transmitted and displayed upon a graphical user interface associated with a data communications device of a gambler such that the video stream and the information provided by the one or more experts is available to the gambler in substantially real-time;
cause odds associated with wagering upon different possible selections by the one or more experts to be transmitted and displayed upon the graphical user interface associated with the data communications device;
receive, from the data communications device, a wager from the gambler in respect of a selection by the gambler of one or more race animals that the gambler predicts will be selected by the one or more experts;
detect, prior to the race event, that a selection had been made by the one or more experts by identifying that the on or more experts has confirmed their opinion with respect to which of the race animals are most race fit and/or most likely to win or be placed at the race event;
based upon detecting that the one or more experts has made a selection of one or more race animals, determine an outcome of the Rambler's wager; and
cause an outcome of the wager to be transmitted and displayed upon the graphical user interface associated with the data communications device.

19. A computer-implemented system according to claim 18, the system configured to transport an activatable link to the data communications device, the activatable link enabling the gambler to request live streaming of the race event in which the one or more animals participate.

20. A non-transitory computer-readable medium having a plurality of instructions that enable a gambler to place a wager in respect of a selection of one or more race animals by one or more experts, the instructions executable by one or more processors to:
receive data relating to a plurality of uniquely identified race animals, the data including:
a video stream of images of the race animals prior to a race event in respect of which the race animals are scheduled to participate, and
information provided by one or more experts assessing the race fitness of the animals during viewing of the video stream;
cause the data to be transmitted and displayed upon a graphical user interface associated with a data communications device of a gambler such that the video stream and the information provided by the one or more experts is available to the gambler in substantially real-time;
cause odds associated with wagering upon different possible selections by the one or more experts to be transmitted and displayed upon the graphical user interface associated with the data communications device;
receive, from the data communications device, a wager from the gambler in respect of a selection by the gambler of one or more race animals that the gambler predicts will be selected by the one or more experts;
detect, prior to the race event, that a selection had been made by the one or more experts by identifying that the one or more experts has confirmed their opinion with respect to which of the race animals are most race fit and/or most likely to win or be placed at the race event;
based upon detecting that the one or more experts has made a selection of one or more race animals, determine an outcome of the wager; and
cause an outcome of the wager to be transmitted and displayed upon the graphical user interface associated with the data communications device.

21. A non-transitory computer readable medium according to claim 20 including instructions that cause an activatable link to be provided to the data communications device, the activatable link enabling the gambler to request live streaming of the race event in which the one or more animals participate.
